(19) United States
(12) Patent Application Publication
(10) Pub. No.: US 2026/0337443 A1
(43) Pub. Date: Oct. 29, 2026

(54) A WATERBORNE COATING COMPOSITION COMPRISING A DISPERSED NON-SENSITIZING ANTI-MICROBIAL COMPOSITION

(71) Applicant: PERSTORP AB, Perstorp (SE)

(72) Inventors: David LÖF, Vellinge (SE); Lotta GLANS, Lund (SE); Magnus JENDBRO, Lund (SE); Håkan BJÖRNBERG, Malmö (SE); Jenny BJÖRK, Klippan (SE); Marie WESTERBLAD, Hässleholm (SE)

(21) Appl. No.: 19/117,736

(22) PCT Filed: Jul. 11, 2023
(86) PCT No.: PCT/SE2023/050729

§ 371 Date: Apr. 2, 2025

(30) Foreign Application Priority Data
Oct. 5, 2022 (SE) 2230322-6

(51) Int. Cl. C09D 175/04; C08K 3/08; C08K 3/22; C08K 3/28; C08K 5/09; C08K 5/47; C09D 5/14; C09D 7/61; C09D 7/63; C09D 167/08

(52) U.S. Cl. CPC C09D 175/04; C08K 3/08; C08K 3/22; C08K 3/28; C08K 5/09; C08K 5/47; C09D 5/14; C09D 7/61; C09D 7/63; C09D 167/08; C08K 2003/0812

(57) ABSTRACT

An anti-microbially inhibited waterborne coating composition comprising;
a) a waterborne polymer resin,
b) an antimicrobial composition,
a) The polymer resin is based on an emulsion polymer resin or a an-ionic or non-ionic stabilized polyurethane dispersion or an alkyd resin.
b) Said antimicrobial composition comprise;
b i) At least one compound selected from the group consisting of, formic acid, metal formate, ammonium formate, propionic acid, metal propionate, ammonium propionate, acetic acid, metal acetate, ammonium acetate, sorbic acid, metal sorbate, ammonium sorbate, and,
b ii) At least one compound selected from the group consisting of; hexanoic acid, metal hexanoate, ammonium hexanoate, heptanoic acid, metal heptanoate, ammonium heptanoate, benzoic acid, metal benzoate, ammonium benzoate, octanoic acid, metal octanoate, ammonium octanoate, nonanoic acid, metal nonanoate, ammonium nonanoate, nonanedioc acid, metal nonanedioate, ammonium nonanedioate, decanoic acid, metal decanoate, ammonium decanoate, undecanoic acid, metal undecanoate, ammonium undecanoate, dodecanoic acid, metal dodecaonoate, -ammonium dodecanoate, and
b iii) at least one compound selected from the group consisting of;
benzisothiazolinone in the range 10-360 ppm, calculated on the coating composition including water diluent and bronopol in the range 10-2000 ppm, calculated on the coating composition including water diluent,
wherein the antimicrobial composition compound b i) together with b ii) constitutes 0.2-5.0% by weight of the coating composition, including water diluent.

The present invention relates to a waterborne coating composition comprising a anti-microbial composition intended for use as preservative in coating compositions.

### FIELD OF THE INVENTION

Coating compositions, also known as paints, have gone through a radical change over the last couple of decades. In some parts of the world this change is still ongoing. The aim to reduce the amount of organic solvents used in coatings have led to radically increased use of waterborne coating compositions. The reduction of volatile organic compounds (VOC) i.e. organic solvents in coatings have led to increased problems with microbial activity in paint cans. Many can report that a previously opened can of paint will have to be disposed of as a microbial contamination caused by for example of bacteria or mold has infected the paint. One known way of solving this well-known issue is to include an anti-microbial agent. Among the most well-known agents in use can be mentioned isothiazolinones such as methylisothiazolinone (MIT), benzisothiazolinone (BIT) and chloromethylisothiazolinone (CMIT). Although very effective, these antimicrobials have become questioned lately as they are known to be sensitizing substances. This will of course lead to allergic reactions caused by long term exposure and since the above mentioned antimicrobials can be found also in many personal care and household products such an allergy can become rather challenging. MIT, BIT and CMIT are used in combination. This is mainly of two reasons, where a first reason is that only one of the three alone would not be able to inhibit a wild strain i.e. multiple different strains of microbial activity. Of the three isothiazolinones specifically the methyl- and chloromethyl-species will be allowed only in levels so low that they no longer will have the desired effect. Benzisothiazolinone will be allowed in use, albeit at a slightly lower level than before. This do cause a problem especially with concern of wild strain microbial activity. The above MIT, BIT and CMIT are known to be combined with Bronopol (2-bromo-2-nitropropane-1,3-diol) which is known as an effective bactericide, however less effective against fungi and yeast. It is known to us that also Bronopol is under assessment as it is believed to be endocrine disrupting. Bronopol is also known to be toxic to aquatic life so there is reason to use this biocide sparingly.

A second reason relates to the microbes tendency to adapt to new environments. Simply put, use of only one biocide will over time prove useless as microbes will inevitably adapt to this single biocide. It is therefore of great importance to find alternatives to MIT and CMIT that may complement BIT in a biocide formulation.

Not only do the increased use of water as sole solvent in coating compositions create problem for the end user, it also creates problems in the manufacturing lines. Here hygiene has become an increased focus area as remaining microbial contamination forming a biofilm in the rather complex make-up of the production apparatus can remain for years and cause bigger problems than ordinary man could conceive. Introduction of antimicrobial agents will of course counteract microbial growth but the sensitizing antimicrobials will end up in the coating composition and may accordingly affect the end user.

It has been found that microbial growth is greatly affected by how well the anti-microbial agents are distributed. In cases where these anti-microbial compositions are allowed to agglomerate, quite a bit more will have to be added to obtain the desired effect. It has been found that agglomerates or uneven distribution of the antimicrobials in a coating composition will leave areas, albeit small, where microbiota can attach and reproduce. Adding more anti-microbial agents would of course solve the problem but too much would effect the mechanical properties of the coating. As an example of properties effected can be mentioned; film hardness, dry-time, gloss rate, film forming properties during application, adhesion to substrate etc. Some of these properties will be discussed in more detail together with embodiment of the invention.

Accordingly, the invention relates to an anti-microbially inhibited waterborne coating composition comprising;
a) a waterborne emulsion polymer resin and,
b) an antimicrobial composition,

The invention is characterized in that,
a) The emulsion polymer resin is based on a radical polymerization polymer selected from the group consisting of; vinyl acetate (PVA) polymer, vinyl acetate/ethylene (VAE) copolymer, vinyl acrylic copolymer, acrylic polymer, styrene acrylic copolymer, vinyl acetate/ethylene/vinyl chloride copolymer, vinyl acetate versatate and combinations thereof.
b) That said antimicrobial composition comprise;
b i) at least one compound selected from the group consisting of, formic acid, metal formate, ammonium formate, propionic acid, metal propionate, ammonium propionate, acetic acid, metal acetate, ammonium acetate, sorbic acid, metal sorbate, ammonium sorbate, and, b ii) at least one compound selected from the group consisting of; hexanoic acid, metal hexanoate, ammonium hexanoate, heptanoic acid, metal heptanoate, ammonium heptanoate, benzoic acid, metal benzoate, ammonium benzoate, octanoic acid, metal octanoate, ammonium octanoate, nonanoic acid, metal nonanoate, ammonium nonanoate, nonanedioc acid, metal nonanedioate, ammonium nonanedioate, decanoic acid, metal decanoate, ammonium decanoate, undecanoic acid, metal undecanoate, ammonium undecanoate, dodecanoic acid, metal dodecaonoate, -ammonium dodecanoate, and
b iii) at least one compound selected from the group consisting of; benzisothiazolinone in the range 10-360 ppm, calculated on the coating composition including water diluent and bronopol in the range 10-2000 ppm, calculated on the coating composition including water diluent, wherein the antimicrobial composition compound b i) together with b ii) constitutes 0.2-5.0% by weight of the coating composition, including water diluent.

According to one embodiment of the invention benzisothiazolinone comprises 10-200 ppm of the coating composition including water diluent.

According to a more preferred embodiment of the invention benzisothiazolinone comprises 10-100 ppm of the coating composition including water diluent.

According to one embodiment of the invention bronopol comprises 10-200 ppm of the coating composition including water diluent.

In a first alternative embodiment of the invention an anti-microbially inhibited waterborne coating composition comprises;
a) A waterborne polyurethane resin and,
b i) at least one compound selected from the group consisting of, formic acid, metal formate, ammonium formate, propionic acid, metal propionate, ammonium propionate, acetic acid, metal acetate, ammonium acetate, sorbic acid, metal sorbate, ammonium sorbate, and,
b ii) at least one compound selected from the group consisting of; hexanoic acid, metal hexanoate, ammonium hexanoate, heptanoic acid, metal heptanoate, ammonium heptanoate, benzoic acid, metal benzoate, ammonium benzoate, octanoic acid, metal octanoate, ammonium octanoate, nonanoic acid, metal nonanoate, ammonium nonanoate, nonanedioc acid, metal nonanedioate, ammonium nonanedioate, decanoic acid, metal decanoate, ammonium decanoate, undecanoic acid, metal undecanoate, ammonium undecanoate, dodecanoic acid, metal dodecaonoate, -ammonium dodecanoate, and
b iii) at least one compound selected from the group consisting of; benzisothiazolinone in the range 10-360 ppm, calculated on the coating composition including water diluent and bronopol in the range 10-2000 ppm, calculated on the coating composition including water diluent,
wherein the antimicrobial composition compound b i) together with b ii) constitutes 0.2-5.0% by weight of the coating composition, including water diluent.

According to one embodiment of the invention benzisothiazolinone comprises 10-200 ppm of the coating composition including water diluent.

According to a more preferred embodiment of the invention benzisothiazolinone comprises 10-100 ppm of the coating composition including water diluent.

According to one embodiment of the invention bronopol comprises 10-200 ppm of the coating composition including water diluent.

In a second alternative embodiment of the invention an anti-microbially inhibited waterborne coating composition comprises;
a) A waterborne resin and,
b) an antimicrobial composition,

The invention is characterized in that,
a) The waterborne coating composition is based on an alkyd resin and,
b) that said antimicrobial composition comprise;
b i) at least one compound selected from the group consisting of, formic acid, metal formate, ammonium formate, propionic acid, metal propionate, ammonium propionate, acetic acid, metal acetate, ammonium acetate, sorbic acid, metal sorbate, ammonium sorbate, and,
b ii) at least one compound selected from the group consisting of; hexanoic acid, metal hexanoate, ammonium hexanoate, heptanoic acid, metal heptanoate, ammonium heptanoate, benzoic acid, metal benzoate, ammonium benzoate, octanoic acid, metal octanoate, ammonium octanoate, nonanoic acid, metal nonanoate, ammonium nonanoate, nonanedioc acid, metal nonanedioate, ammonium nonanedioate, decanoic acid, metal decanoate, ammonium decanoate, undecanoic acid, metal undecanoate, ammonium undecanoate, dodecanoic acid, metal dodecaonoate, -ammonium dodecanoate, and
b iii) at least one compound selected from the group consisting of; benzisothiazolinone in the range 10-360 ppm, calculated on the coating composition including water diluent and bronopol in the range 10-2000 ppm, calculated on the coating composition including water diluent,
wherein the antimicrobial composition compound b i) together with b ii) constitutes 0.2-5.0% by weight of the coating composition, including water diluent.

According to one embodiment of the invention benzisothiazolinone comprises 10-200 ppm of the coating composition including water diluent.

According to a more preferred embodiment of the invention benzisothiazolinone comprises 10-100 ppm of the coating composition including water diluent.

According to one embodiment of the invention bronopol comprises 10-200 ppm of the coating composition including water diluent.

The anti-microbially inhibited waterborne coating composition advantageously further comprises an agglomeration inhibitor being based on a linear or branched C12-C30 alkyl tail and an-ionic or non-ionic head. Such an agglomeration inhibitor will serve the purpose of dispersing the compound and keep it in suspension.

In one embodiment of the invention b i) constitutes at least 0.3% by weight of the coating composition. In another embodiment of the invention b i) constitutes at least 0.5% by weight of the coating composition. In yet another embodiment of the b i) constitutes at least 1% by weight of the coating composition.

In another embodiment of the invention b ii) constitutes at least 0.3% by weight of the coating composition. In yet another embodiment of the invention b ii) constitutes at least 0.5% by weight of the coating composition. In a further embodiment of the invention b ii) constitutes at least 1% by weight of the coating composition.

pH in the anti-microbially inhibited waterborne coating composition is suitably adjusted to pH 7.5-9.5 by adding an alkali metal hydroxide or ammonia.

The metal of said metal compound is preferably selected from the group consisting of; sodium, potassium, calcium, magnesium and zinc.

According to a preferred embodiment of the invention the anti-microbially inhibited waterborne coating composition comprises,
b i) At least one compound selected from the group consisting of, formic acid, metal formate, ammonium formate, propionic acid, metal propionate, ammonium propionate, sorbic acid, metal sorbate, ammonium sorbate, and,
b ii) At least one compound selected from the group consisting of; benzoic acid, metal benzoate, ammonium benzoate, nonanoic acid, metal nonanoate, ammonium nonanoate, nonanedioc acid, metal nonanedioate, ammonium nonanedioate, dodecanoic acid, metal dodecaonoate, ammonium dodecanoate, and
b iii) At least one compound selected from the group consisting of;
benzisothiazolinone in the range 10-360 ppm, calculated on the coating composition including water diluent and bronopol in the range 10-2000 ppm, calculated on the coating composition including water diluent,
wherein the antimicrobial composition compound b i) together with b ii) constitutes 0.5-5.0% by weight of the coating composition, including water diluent.

Said antimicrobial composition is according to one embodiment of the invention added to the coating composition before adding further coating components, said components including pigments, rheologic modifiers and dispersing agents.

Said antimicrobial composition is according to one embodiment of the invention utilized for reducing microbial contamination inside a process equipment used for producing said coating compositions. It is here noted that for example one component, such as b ii) may be added early in the process while the other component, such as b i) may be added at a later stage in the process.

Said antimicrobial composition is advantageously utilized for reducing microbial contamination and extending shelf life on coating compositions.

### EMBODIMENT EXAMPLES

Embodiment example 1 where Table 1 shows results from comparative trials of antimicrobial effect between different combinations of compositions according to the invention also evaluation the effects of a good distribution.

Embodiment example 2 where Table 2 shows results from synergistic effect between an embodiment of the present invention and biocides at normally insufficient levels.

Embodiment example 3 where Table 3 shows the antimicrobial effect on two embodiments of the present invention.

Accordingly, a series of trials were performed where a waterborne paint formulation containing different combinations of antimicrobial compositions was inoculated repeatedly. Analysis were performed at 7 and 30 days after each inoculation. The analysis comprised of an Adenosine TrisPhosphate measurement (ATP) as well as an ocular observation for visible growth.
ATP levels below 100 are considered as no significant contamination
ATP levels between 100 and 1000 are considered as acceptable contamination
ATP levels above 1000 are considered as a problematic (possibly uncontrollable) contamination

The ocular observations were classified as follows;
No growth
Little growth
Growth
Overgrowth

### Embodiment Example 1

In a first trial the coating compositions according to the invention where inoculated repeatedly until they started to fail at the 7 day observation. In this experiment a mix between equal amounts by weight of;
Sample number 1, Sodium Benzoate (SoBe) and Potassium Sorbate (PoSo),
Sample number 2, Sodium Propionate (SoPr) and Potassium Sorbate (PoSo),
Sample number 3, Sodium Acetate (SoAc) and Potassium Sorbate (PoSo),
Sample number 4, Sodium Formate (SoFo) and Potassium Sorbate (PoSo),

Comparative, Biocide consisting of, Benzisothiazolinone (200 ppm), Methylisothiazolinone (4 ppm), Chloromethylisothiazolinone (11 ppm) and Bronopol (110 ppm).

All tests were performed in duplicates or triplicates.

TABLE 1
Results after inoculation with 0.2 ml of Pseudomonas aeruginosa

| Sample | Antimicrobial | % by | | 7 days | | 30 days | |
|---|---|---|---|---|---|---|---|
| number | composition | weight | pH | ATP | Ocular | ATP | Ocular |
| 1a | C12 + SoPr | 1 + 1 | 9.1 | 19.077 | No | 11.528 | No |
| | | | | | growth | | growth |
| 1b | C12 + SoPr | 1 + 1 | 9.1 | 801 | No | 6.348 | No |
| | | | | | growth | | growth |
| 1c | C12 + SoPr + | 1 + 1 + 0.33 | 9.2 | 37 | No | 244 | No |
| | AI | | | | growth | | growth |
| 1d | C12 + SoPr + | 1 + 1 + 0.33 | 9.2 | 44 | No | 381 | No |
| | AI | | | | growth | | growth |
| 2a | C12 + SoFo | 1 + 1 | 9 | 178 | No | 8.518 | No |
| | | | | | growth | | growth |
| 2b | C12 + SoFo | 1 + 1 | 9 | 128 | No | 1.316 | No |
| | | | | | growth | | growth |
| 2c | C12 + SoFo + | 1 + 1 + 0.33 | 9 | 47 | No | 690 | No |
| | AI | | | | growth | | growth |
| 2d | C12 + SoFo + | 1 + 1 + 0.33 | 9 | 40 | No | 575 | No |
| | AI | | | | growth | | growth |
| Comparative | AI only | 0.33 | 9 | 65.879 | Growth | 726.778 | Growth |
| A | | | | | | | |
| Comparative | AI only | 0.33 | 9 | 67.245 | Growth | 171.336 | Growth |
| A | | | | | | | |

Conclusions; In this study the combinatory effect of lauric acid and sodium propionate or sodium formate was studied (sample 1a-b-2c-d). It was assumed that a good dispersion of the lauric acid was important in order to obtain full antimicrobial effect. For this reason an agglomeration inhibitor (AI) was added in samples 1c-d and 2c-d. In order to assure that this agglomeration inhibitor did not have any antimicrobial properties it was tested in Comparative A. It is clear from the above that a good dispersion of the antimicrobial composition is important in order to provide the desired effect. It is also clear from the Comparative A sample that said agglomeration inhibitor does not seem to have any apparent antimicrobial properties. Even though sample 1a showed increased, possibly uncontrollable ATP levels after 7 days it recovered somewhat after 30 days. This being observed, the most important takeaway from the above results is that no visible growth can be detected in any of the samples 1a-d, & 2a-d.

In a second trial the coating compositions according to the invention where inoculated repeatedly until they started to fail at the 7 day observation. In this experiment a mix between equal amounts by weight of;

Sample number 3a-c, Sodium Benzoate (SoBe) and Potassium Sorbate (PoSo), Comparative B, Biocide consisting of, Benzisothiazolinone (200 ppm), Methylisothiazolinone (4 ppm), Chloromethylisothiazolinone (11 ppm) and Bronopol (110 ppm).

All tests were performed in triplicates.

Results after the last inoculation with 4.8 ml of Pseudomonas aeruginosa

TABLE 2

| Sample | Antimicrobial | % by | | 7 days | | 30 days | |
|---|---|---|---|---|---|---|---|
| number | composition | weight | pH | ATP | Ocular | ATP | Ocular |
| 3a | SoBe + PoSo | 3 | 8.4 | 1.751 | No | 420 | No |
| | | | | | growth | | growth |
| 3b | SoBe + PoSo | 3 | 8.4 | 1.644 | No | 445 | No |
| | | | | | growth | | growth |
| 3c | SoBe + PoSo | 3 | 8.4 | 1.609 | No | 482 | No |
| | | | | | growth | | growth |
| Comparative | Biocide | As defined | 8.7 | 277.899 | Growth | 19.857 | Growth |
| B | | above | | | | | |
| Comparative | Biocide | As defined | 8.7 | 331.828 | Growth | 204.039 | Growth |
| B | | above | | | | | |
| Comparative | Biocide | As defined | 8.7 | 307.924 | Growth | 144.631 | Growth |
| B | | above | | | | | |

Conclusions; It has been suspected that the ban on methylisothiazolinone and chloromethylisothiazolinone together with lowered maximum presence of benzisothiazolinone to 360 ppm would not be sufficient to inhibit spontaneous biocontamination of waterborne coating compositions. The combinatory effect of benzisothiazolinone (200 ppm) and bronopol (110 ppm) is evidently also not sufficient at levels that is considered safe from health and environmental consideration. It is clear from the above that moderate levels of acid salts in accordance to the invention do have a sufficient long term effect. Even though samples 3a-c “problematic” ATP levels after 7 days they both recovered to acceptable levels after 30 days. This indicates a desired robustness to the system. This being observed, the most important takeaway from the above results is that no visible growth can be detected in any of the samples 3a-c.

### Embodiment Example 3

In a third trial the coating compositions according to the invention where inoculated with 0.2 ml of Pseudomonas aeruginosa. The samples were then observed and measured at 7 and 30 days after inoculation. In this experiment a mix as defined below were added in % by weight, as specified in table 3, calculated on the whole composition including water;

Sample Number 4a-4b,

Lauric acid (C12), Sodium Propionate (SoPr) and Sodium Formate (SoFo), biocide consisting of, Benzisothiazolinone (200 ppm), Methylisothiazolinone (4 ppm), Chloromethylisothiazolinone (11 ppm) and Bronopol (110 ppm)

Sample Number 5a-5b,

Lauric acid (C12), -Sodium Propionate (SoPr) and Sodium Formate (SoFo), Biocide consisting of, Benzisothiazolinone (200 ppm), Methylisothiazolinone (4 ppm), Chloromethylisothiazolinone (11 ppm) and Bronopol (110 ppm).

Results after inoculation with 0.2 ml of Pseudomonas aeruginosa

TABLE 3

| Sample | Antimicrobial | | | 7 days | | 30 days | |
|---|---|---|---|---|---|---|---|
| number | composition | % by weight | pH | ATP | Ocular | ATP | Ocular |
| 4a | C12 + SoPr + | 0.66 + 0.33 + | 8.8 | 81 | No | 20 | No |
| | SoFo + | 0.33 + ada* | | | growth | | growth |
| | biocide | | | | | | |
| 4b | C12 + SoPr + | 0.66 + 0.33 + | 8.8 | 79 | No | 18 | No |
| | SoFo + | 0.33 + ada* | | | growth | | growth |
| | biocide | | | | | | |
| 5a | C12 + SoPr + | 0.33 + 0.66 + | 8.5 | 96 | No | 29 | No |
| | SoFo + | 0.33 + ada* | | | growth | | growth |
| | biocide | | | | | | |
| 5b | C12 + SoPr + | 0.33 + 0.66 + | 8.5 | 132 | No | 27 | No |
| | SoFo + | 0.33 + ada* | | | growth | | growth |
| | biocide | | | | | | |

Ada* = as defined above i.e. the amount of biocide added

Conclusions; It has been suspected that the ban on methylisothiazolinone and chloromethylisothiazolinone together with lowered maximum presence of benzisothiazolinone to 360 ppm would not be sufficient to inhibit spontaneous biocontamination of waterborne coating compositions. The combinatory effect of benzisothiazolinone (200 ppm) and bronopol (110 ppm) is evidently also not sufficient at levels that is considered safe from health and environmental consideration as shown in table 2 (Comparative B). It is clear from the above that moderate levels of acid salts in accordance to the invention do have a sufficient long term effect. Even though sample 5b showed slightly increased, but still acceptable ATP levels after 7 days it recovered to “no contamination” levels after 30 days. This indicates a desired robustness to the system. This being observed, the most important takeaway from the above results is that no visible growth can be detected in any of the samples 4a-b & 5a-b.

1-19. (canceled)

20. An anti-microbially inhibited waterborne coating composition comprising:
(a) a waterborne resin selected from:
(i) a waterborne emulsion polymer resin, wherein the polymer is formed through radical polymerization and is selected from polyvinyl acetate (PVA), vinyl acetate/ethylene (VAE) copolymer, vinyl acrylic copolymer, acrylic polymer, styrene acrylic copolymer, vinyl acetate/ethylene/vinyl chloride (VAE-VC) copolymer, and vinyl acetate versatate (VAVT);
(ii) an anionic or nonionic waterborne polyurethane resin; and
(iii) a waterborne alkyd resin; and
(b) an antimicrobial composition comprising;
(i) at least one compound selected from formic acid, metal formate, ammonium formate, propionic acid, metal propionate, ammonium propionate, acetic acid, metal acetate, ammonium acetate, sorbic acid, metal sorbate, and ammonium sorbate; and
(ii) at least one compound selected from hexanoic acid, metal hexanoate, ammonium hexanoate, heptanoic acid, metal heptanoate, ammonium heptanoate, benzoic acid, metal benzoate, ammonium benzoate, octanoic acid, metal octanoate, ammonium octanoate, nonanoic acid, metal nonanoate, ammonium nonanoate, nonanedioc acid, metal nonanedioate, ammonium nonanedioate, decanoic acid, metal decanoate, ammonium decanoate, undecanoic acid, metal undecanoate, ammonium undecanoate, dodecanoic acid, metal dodecaonoate, and ammonium dodecanoate,
wherein (b) (i) and (b) (ii) together constitute 0.2 to 5.0 wt. % of the composition, based on a total weight of the composition including water diluent; and
(iii) at least one compound selected from benzisothiazolinone, in an amount of 10 to 360 ppm, and bronopol, in and amount of 10 to 2000 ppm, based on the total weight of the composition, including the water diluent.

21. The composition of claim 20, wherein the waterborne resin is the waterborne polyurethane resin.

22. The composition of claim 20, wherein the waterborne resin is the waterborne alkyl resin.

23. The composition of claim 20, wherein the benzisothiazolinone is in an amount of 10 to 200 ppm.

24. The composition of claim 20, wherein the benzisothiazolinone is in an amount of 10 to 100 ppm.

25. The composition of claim 20, wherein the bronopol is in an amount of 10 to 200 ppm.

26. The composition of claim 20, wherein the composition further comprises an agglomeration inhibitor, which is based on a linear or branched C12-C30 alkyl tail and an anionic or nonionic head group.

27. The composition of claim 20, wherein (b) (i) is in an amount of at least 0.3 wt. %.

28. The composition of claim 20, wherein (b) (ii) is in an amount of at least 0.3 wt. %.

29. The composition of claim 20, wherein (b) (i) is in an amount of at least 0.5 wt. %.

30. The composition of claim 20, wherein (b) (ii) is in an amount of at least 0.5 wt. %.

31. The composition of claim 21, wherein (b) (i) is in an amount of at least 1 wt. %.

32. The composition of claim 20, wherein (b) (ii) is in an amount of at least 1 wt. %.

33. The composition of claim 20, wherein the composition has a pH of 7.5-9.5, adjusted by addition of an alkali metal hydroxide or ammonia.

34. The composition of claim 33, wherein the alkali metal is selected from sodium, potassium, calcium, magnesium, and zinc.

35. The composition of claim 20, wherein the antimicrobial composition comprises:
(i) formic acid, metal formate, ammonium formate, propionic acid, metal propionate, ammonium propionate, sorbic acid, metal sorbate, and ammonium sorbate;
(ii) at least one compound selected from benzoic acid, metal benzoate, ammonium benzoate, nonanoic acid, metal nonanoate, ammonium nonanoate, nonanedioc acid, metal nonanedioate, ammonium nonanedioate, dodecanoic acid, metal dodecaonoate, and ammonium dodecanoate;
wherein (b) (i) and (b) (ii) together constitute 0.5 to 5.0 wt. % of the composition, based on a total weight of the composition, including water diluent; and
(iii) at least one compound selected from benzisothiazolinone, in an amount of 10 to 360 ppm, and bronopol, in and amount of 10 to 2,000 ppm, based on the total weight of the composition, including the water diluent.

36. A method for making the anti-microbially inhibited waterborne coating composition of claim 20 comprising, adding the antimicrobial composition (b) to the waterborne resin (a) before adding additional coating components selected from pigments, rheology modifiers, and dispersing agents.

37. A method for reducing microbial contamination of process equipment comprising producing the anti-microbially inhibited waterborne coating composition of claim 20 in the process equipment.

38. A method for reducing microbial contamination of a waterborne coating composition and extending its shelf life comprising, incorporating an antimicrobial composition into the waterborne coating composition, wherein the antimicrobial composition comprises:
(i) at least one compound selected from formic acid, metal formate, ammonium formate, propionic acid, metal propionate, ammonium propionate, and optionally acetic acid, metal acetate, and ammonium acetate;
(ii) at least one compound selected from sorbic acid, metal sorbate, ammonium sorbate, benzoic acid, metal benzoate, and ammonium benzoate;
wherein (b) (i) and (b) (ii) together constitute 0.2 to 5.0 wt. % of the composition, based on a total weight of the composition including water diluent; and
(iii) at least one compound selected from benzisothiazolinone, in an amount of 10 to 360 ppm, and bronopol, in and amount of 10 to 2000 ppm, based on the total weight of the composition, including the water diluent.
